(19) United States
(12) Patent Application Publication
(10) Pub. No.: US 2025/0148223 A1
(43) Pub. Date: May 8, 2025

(54) ELECTRONIC DEVICE FOR GENERATING TRANSLATED TEXT USING TRANSLATION METHOD SELECTED FROM PLURALITY OF TRANSLATION METHODS, AND METHOD FOR GENERATING TRANSLATED TEXT

(71) Applicant: Samsung Electronics Co., Ltd., Suwon-si (KR)

(72) Inventors: Yonghyun RYU, Suwon-si (KR); Jiho SHIN, Suwon-si (KR)

(21) Appl. No.: 19/013,494

(22) Filed: Jan. 8, 2025

Related U.S. Application Data
(63) Continuation of application No. PCT/KR2023/010121, filed on Jul. 14, 2023.

(30) Foreign Application Priority Data
Sep. 2, 2022 (KR) 10-2022-0111741

(51) Int. Cl. G06F 40/58; G06F 40/279; G06F 40/30

(52) U.S. Cl. CPC G06F 40/58; G06F 40/279; G06F 40/30

(57) ABSTRACT

An electronic device is disclosed. The electronic device comprises: a memory storing a first translation model configured to translate using a first translation method and a second translation model configured to translate using a second translation method; and at least one processor, comprising processing circuitry, individually and/or collectively, is configured to: based on original text and a translation intention being input, identify whether a word corresponding to the translation intention exists in learning data; based on a word corresponding to the translation intention existing in the learning data, generate first translated text of the original text based on the first translation model and the translation intention; and, based on a word corresponding to the translation intention not existing in the learning data, generate second translated text of the original text based on the second translation model and the translation intention.

### CROSS-REFERENCE TO RELATED APPLICATIONS

This application is a continuation of International Application No. PCT/KR2023/010121 designating the United States, filed on Jul. 14, 2023, in the Korean Intellectual Property Receiving Office and claiming priority to Korean Patent Application No. 10-2022-0111741, filed on Sep. 2, 2022, in the Korean Intellectual Property Office, the disclosures of each of which are incorporated by reference herein in their entireties.

### BACKGROUND

### Field

The disclosure relates to an electronic device generating a translated text using a translation method, and a method for generating a translated text thereof.

### Description of Related Art

Spurred by the development of electronic technologies, a user can be provided with various functions through an electronic device. For example, a user can be provided with a translation service through an electronic device.

For example, if a translation request for an original text is received, an electronic device may generate a translated text by performing translation for the original text, and provide the generated translated text to a user.

### SUMMARY

An electronic device according to an example embodiment of the disclosure includes: memory storing a first translation model configured to perform translation using a first translation method and a second translation model configured to perform translation using a second translation method, and at least one processor, comprising processing circuitry. At least one processor, individually and/or collectively, is configured to: based on an original text and a translation intention being input, identify whether a word corresponding to the translation intention exists in training data; based on a word corresponding to the translation intention existing in the training data, generate a first translated text for the original text based on the first translation model and the translation intention; and based on a word corresponding to the translation intention not existing in the training data, generate a second translated text for the original text based on the second translation model and the translation intention.

A method for generating a translated text by an electronic device according to an example embodiment of the disclosure includes: based on an original text and a translation intention being input, identifying whether a word corresponding to the translation intention exists in training data, and based on a word corresponding to the translation intention existing in the training data, generating a first translated text for the original text based on a first translation model configured to perform translation using a first translation method and the translation intention, and based on a word corresponding to the translation intention not existing in the training data, generating a second translated text for the original text based on a second translation model configured to perform translation using a second translation method and the translation intention.

In a non-transitory computer-readable medium storing computer instructions that, when executed by at least one processor, comprising processing circuitry, of an electronic device, individually and/or collectively, cause the electronic device perform operations, the operations including: based on an original text and a translation intention being input, identifying whether a word corresponding to the translation intention exists in training data, and based on a word corresponding to the translation intention existing in the training data, generating a first translated text for the original text based on a first translation model configured to perform translation using a first translation method and the translation intention, and based on a word corresponding to the translation intention not existing in the training data, generating a second translated text for the original text based on a second translation model configured to perform translation using a second translation method and the translation intention.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a diagram for illustrating an electronic device according to various embodiments;

FIG. 2 is a block diagram illustrating an example configuration of an electronic device according to various embodiments;

FIG. 3 is a flowchart illustrating an example translation method according to various embodiments;

FIG. 4 is a illustrating an example translation method according to various embodiments;

FIG. 5 is a block diagram illustrating an example configuration of an electronic device according to various embodiments; and

FIG. 6 is a flowchart illustrating an example method for generating a translated text of an electronic device according to various embodiments.

### DETAILED DESCRIPTION

Various modifications may be made to the various example embodiments of the disclosure, and there may be various types of embodiments. Accordingly, example embodiments will be illustrated in drawings, and the various embodiments will be described in greater detail in the following description. However, it should be noted that the various embodiments do not limit the scope of the disclosure to a specific embodiment, but they should be interpreted to include all modifications, equivalents, and/or alternatives of the various embodiments of the disclosure. With respect to the detailed description of the drawings, similar components may be designated by similar reference numerals.

In case it is determined that in describing the disclosure, detailed explanation of related known functions or components may unnecessarily confuse the gist of the disclosure, the detailed explanation may be omitted.

The various example embodiments below may be modified in various different forms, and the scope of the technical idea of the disclosure is not limited to the various example embodiments below. Rather, these embodiments are provided to make the disclosure more sufficient and complete.

The terms used in the disclosure are used simply to explain various embodiments of the disclosure, and are not intended to limit the scope of the various embodiments. In addition, singular expressions include plural expressions, unless defined differently in the context.

In the disclosure, expressions such as “have,” “may have,” “include,” and “may include” denote the existence of such characteristics (e.g.: elements such as numbers, functions, operations, and components), and do not exclude the existence of additional characteristics.

In the disclosure, the expressions “A or B,” “at least one of A and/or B,” or “one or more of A and/or B” and the like may include all possible combinations of the listed items. For example, “A or B,” “at least one of A and B,” or “at least one of A or B” may refer to all of the following cases: (1) including at least one A, (2) including at least one B, or (3) including at least one A and at least one B.

The expressions “first,” “second,” and the like used in the disclosure may describe various elements regardless of any order and/or degree of importance. Also, such expressions are used simply to distinguish one element from another element, and are not intended to limit the elements.

The description in the disclosure that one element (e.g.: a first element) is “(operatively or communicatively) coupled with/to” or “connected to” another element (e.g.: a second element) should be interpreted to include both the case where the one element is directly coupled to the another element, and the case where the one element is coupled to the another element through still another element (e.g.: a third element).

The description that one element (e.g.: a first element) is “directly coupled” or “directly connected” to another element (e.g.: a second element) can be interpreted to refer to still another element (e.g.: a third element) does not exist between the one element and the another element.

The expression “configured to” used in the disclosure may be interchangeably used with other expressions such as “suitable for,” “having the capacity to,” “designed to,” “adapted to,” “made to,” and “capable of,” depending on cases. Meanwhile, the term “configured to” may not necessarily refer to a device being “specifically designed to” in terms of hardware.

Under some circumstances, the expression “a device configured to” may refer, for example, to the device “is capable of” performing an operation together with another device or component. For example, the phrase “a processor configured to perform A, B, and C” may refer, for example, to a dedicated processor (e.g.: an embedded processor) for performing the corresponding operations, or a generic-purpose processor (e.g.: a CPU or an application processor) that can perform the corresponding operations by executing one or more software programs stored in a memory device.

In the various embodiments of the disclosure, ‘a module’ or ‘a unit’ may perform at least one function or operation, and may be implemented as hardware or software, or as a combination of hardware and software. Further, a plurality of ‘modules’ or ‘units’ may be integrated into at least one module and implemented as at least one processor, excluding ‘a module’ or ‘a unit’ that needs to be implemented as specific hardware.

Various elements and areas in the drawings were illustrated schematically. Accordingly, the technical idea of the disclosure is not limited by the relative sizes or intervals illustrated in the accompanying drawings.

Hereinafter, various example embodiments according to the disclosure will be described in greater detail with reference to the accompanying drawings.

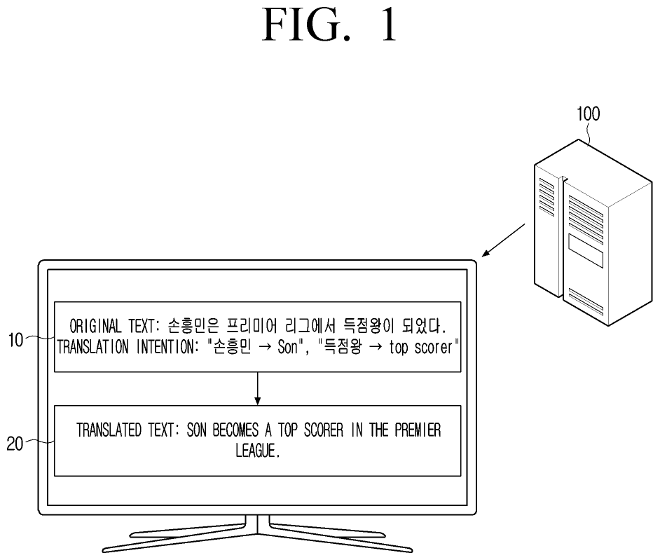

FIG. 1 is a diagram illustrating an example electronic device according to various embodiments.

Referring to FIG. 1, the electronic device 100 may perform translation. For example, the electronic device 100 may generate a translated text by performing translation for an original text 10 using a translation model.

In this case, the electronic device 100 according to an embodiment of the disclosure may provide a translated text 20 that was translated using a specific translation method among a plurality of translation methods, in consideration of whether the translation model learned a word corresponding to a user's translation intention, and whether a word corresponding to the user's translation intention was reflected to the translated text.

Therefore, according to the disclosure, a translated text for an original text can be provided in consideration of various translation methods, and thus the translation quality can be further improved.

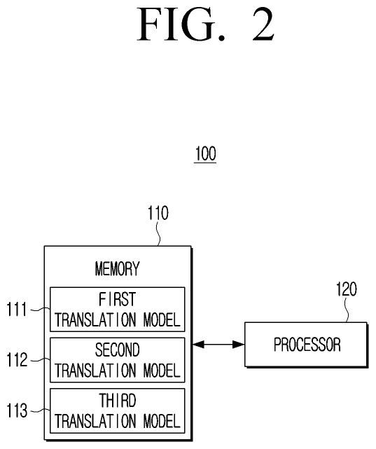

FIG. 2 is a block diagram illustrating an example configuration of an electronic device according to various embodiments.

Referring to FIG. 2, the electronic device 100 includes memory 110 and a processor (e.g., including processing circuitry) 120.

The memory 110 may store instructions or programs related to at least one component of the electronic device 100. For this, the memory 120 may be implemented as non-volatile memory, volatile memory, flash-memory, a hard disc drive (HDD), or a solid state drive (SSD), etc. The memory 110 may be accessed by the processor 120, and reading/recording/correction/deletion/update, etc. of data by the processor 130 may be performed. Also, in the disclosure, the term memory may include the memory 110, ROM (not shown) and RAM (not shown) inside the processor 120, or a memory card (not shown) (e.g., a micro SD card, a memory stick) installed on the electronic device 100.

In the memory 110, translation models and training data used in training of the translation models may be stored. The translation models may be artificial intelligence models that were trained to generate a translated text by performing translation for an original text. In this case, the translation models may include artificial intelligence models based on deep learning. The training data may include corpora.

In this case, the memory 110 may store first to third translation models. Here, the translation models may perform translation using different translation methods.

For example, the first translation model may perform translation using a first translation method. The second translation model may perform translation using a second translation method. The third translation model may perform translation using a third translation method.

For example, the first translation method may be a target lemma annotation (TLA) method. The second translation method may be a placeholder method. The third translation method may be a constrained decoding method.

The processor 120 may include various processing circuitry and be electrically connected with the memory 110, and control the overall operations and functions of the electronic device 100. The processor 120 may control the overall operations of the electronic device 100 using various types of instructions or programs stored in the memory 110. For example, according to an embodiment, a main CPU may copy a program in RAM according to an instruction stored in ROM, and access the RAM and execute the program. The program may include an artificial intelligence model, etc. The processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

For example, the processor 120 may perform translation using a translation model stored in the memory 110. The processor 120 may generate a translated text for an original text using the translation model. The processor 120 may provide the generated translated text. In this case, as an example, the processor 120 may transmit a translated text in the form of a text or a voice to an external electronic device. In this case, the external electronic device may display the translated text received from the electronic device 100 on a display of the external electronic device, or provide the translated text in the form of a voice through a speaker.

For example, the processor 120 may receive a translation request for an original text. For example, the processor 120 may receive input of an original text and a user's translation intention. In this case, the translation request for the original text may be received from an external electronic device. For example, the user may input an original text and the user's translation intention into an external electronic device through a keyboard, a virtual keyboard, etc. provided on the external electronic device. In this case, the external electronic device may transmit the input original text and user's translation intention to the electronic device 100.

The user's translation intention may be the user's translation guide for a specific word (or a phrase, a clause) included in the original text.

For example, a case wherein a sentence in a first language is translated into a sentence in a second language is assumed. In this case, the user's translation intention may be the user's guide regarding into which word in the second language a specific word included in the sentence in the first language should be translated. Accordingly, the user's translation intention may include a pair of a first word in the first language and a second word which is a translation of the first word into the second language.

When an original text and the user's translation intention are input, the processor 120 may select a translation method among a plurality of translation methods, and provide a translated text that was translated using the selected translation method.

For example, when an original text and the user's translation intention are input, the processor 120 may identify whether a word corresponding to the user's translation intention exists in the training data. That is, the processor 120 may identify whether the translation model learned a word included in the user's translation intention.

As an example, the processor 120 may identify whether a word corresponding to the translation intention exists in a corpus. Accordingly, in case a word corresponding to the translation intention exists in a corpus, the processor 120 may identify that the word corresponding to the translation intention exists in the training data. As another example, the processor 120 may identify how many words corresponding to the translation intention are included in a corpus, and if the identified number is greater than a predetermined threshold value, the processor 120 may identify that the words corresponding to the translation intention exist in the training data.

Further, in case a word corresponding to the user's translation intention exists in the training data, the processor 120 may generate the first translated text for the original text based on the first translation model and the user's translation intention. Then, the processor 120 may provide the first translated text.

For example, in case the first translation model learned a word included in the user's translation intention, the processor 120 may determine that translation will be performed using the first translation method provided by the first translation model, and perform translation for the original text through the first translation model, and provide a translated text generated by the first translation model.

The first translation model may be a model that was trained to perform translation using a target lemma annotation method.

For example, the target lemma annotation method is a method of inserting a translation hint for a word included in an original text into the original text, and inducing a translation model to output a translation result intended by the user using the original text into which the translation hint was inserted.

For example, a case wherein a translation request including an original text: “ [symbol] [symbol] [symbol] ” and a translation intention: “ [symbol] =Son, [symbol] =top scorer” was received is assumed.

In this case, for using the words included in the user's translation intention as the translation hints for the first translation model, the processor 120 may convert the input original text like “ [symbol] Son] [symbol] [symbol] :top scorer] [symbol] ” The [symbol] processor 120 may input the converted sentence into the first translation model, and obtain a translated text for the original text from the first translation model.

In this case, the first translation model may perform translation for the input sentence using the translation hints that were already learned, and generate a translated text like “Son becomes a top scorer in the Premier League.”

As described above, according to an embodiment of the disclosure, in case a model by the target lemma annotation method already learned a word corresponding to the translation guide provided by the user, the target lemma annotation method providing a translation result of relatively high quality is used in generation of a translated text.

In case a word corresponding to the user's translation intention does not exist in the training data, the processor 120 may generate the second translated text for the original text based on the second translation model and the user's translation intention. The processor 120 may provide the second translated text.

For example, in case a translation model using the target lemma annotation method translates a sentence including words that were not learned just based on the training data, it is difficult to correctly infer a word corresponding to the user's translation intention, and the translation model may generate a wrong translated text that deviated from the intention.

Accordingly, in case the first translation model did not learn a word included in the user's translation intention, the processor 120 may determine that translation will be performed using the second translation method provided by the second translation model, and perform translation for the original text through the second translation model, and provide a translated text generated by the second translation model.

The second translation model may be a model that was trained to perform translation using the placeholder method.

For example, the placeholder method may refer to a method of substituting a word that is intended to be translated into a specific term in an original text with a placeholder, and translating the remaining parts excluding the part, and then generating a translated text by substituting the placeholder with the specific term.

For example, a case wherein a translation request including an original text: “ [symbol] [symbol] [symbol] ” and a translation intention: “ [symbol] =Son, [symbol] =top scorer” was received is assumed.

In this case, the processor 120 may substitute the words included in the user's translation intention with [NOUN], and generate “[NOUN #0] [symbol] [symbol] [NOUN #1] [symbol] ” The processor 120 may input the substituted sentence into the second translation model, and obtain a translated text for the original text from the second translation model.

In this case, the second translation model may perform translation for the substituted sentence and generate “[NOUN #0] becomes a [NOUN #1] in the Premier League,” and insert the words corresponding to the user's translation intention into [NOUN] and generate a translated text such as “Son becomes a top scorer in the Premier League.”

As described above, according to an embodiment of the disclosure, in the case of the placeholder method, there is an advantage that a word that does not exist in the training data can be translated relatively correctly. Thus, in case a word corresponding to the translation guide provided by the user does not exist in the training data, the placeholder method is used in generation of a translated text.

However, in the case of the placeholder method, as the characteristic of a substituted word is not considered in translation, there is a disadvantage that an unnatural translated text may be generated.

In the aforementioned example, the second translation model may perform translation for the substituted sentence and generate “[NOUN #0] become as [NOUN #1] in the Premier League,” and insert the words corresponding to the user's translation intention into [NOUN] and generate a translated text like “Son become as top scorer in the Premier League.” As can be seen from this, there may be errors which are that subject-verb agreement may not be provided between [NOUN #0] and the verb “become” after that, or an article is not generated before [NOUN #1]. In the case of such errors, they may be resolved through post-processing, but there is inconvenience that a separate engine for this should be constructed.

Accordingly, in the disclosure, in case a model by the target lemma annotation method already learned a word corresponding to the translation guide provided by the user, the target lemma annotation method that can provide translation of higher quality is preferentially used.

Before providing the generated first translated text, the processor 130 may identify whether a word corresponding to the user's translation intention exists in the generated first translated text.

Accordingly, in case a word corresponding to the user's translation intention exists in the first translated text, the processor 130 may provide the first translated text. However, in case a word corresponding to the user's translation intention does not exist in the first translated text, the processor 130 may generate a third translated text for the original text based on the third translation method and the user's translation intention.

For example, in case a translation model using the target lemma annotation method already learned a word provided by the user as the translation guide, a translated text generated by the translation model generally includes the word, but depending on cases, a case wherein the word is not included in a translated text may occur.

In such a case, the processor 130 may determine that translation will be performed using the third translation method provided by the third translation model, and perform translation for the original text through the third translation model, and provide a translated text generated by the third translation model.

The third translation model may be a model that was trained to perform translation using a constrained decoding method.

For example, the constrained decoding method may refer, for example, to a method of generating translation result candidates including words such that words desired by the user are included in a translated text, and generating a translation result candidate having the highest score among the translation result candidates as a translated text.

In the case of the constrained decoding method as above, there is an advantage that intended words can necessarily be included in a translated text. However, in case a word desired to be included in a translated text does not exist in the training data, translation proceeds without including the word, and then the word is added before or after the translated text, and thus there is a disadvantage that an abnormal translated text may be generated.

Accordingly, in case a word corresponding to the translation guide is not included in a translated text generated using the target lemma annotation method, the processor 120 may generate a translated text including a word corresponding to the translation guide using the constrained decoding method.

As described above, according to the disclosure, the electronic device 100 can provide a translated text that was translated using a specific translation method among a plurality of translation methods in consideration of whether a translation model learned a word corresponding to the user's translation intention, and whether a word corresponding to the user's translation intention was reflected to the translated text. Accordingly, a translated text for an original text can be provided in consideration of various translation methods, and thus the translation quality can be further improved. For example, a more natural translated text can be provided for a jargon or a newly-coined word, etc. Also, the methods for generating a translated text according to the disclosure are applied to a computer aided translation (CAT) system, and thus translation can be performed effectively.

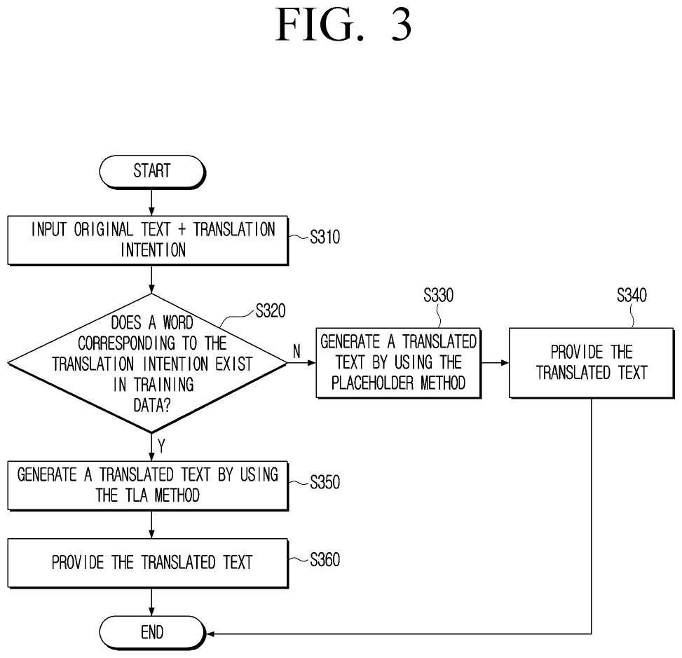

FIG. 3 is a flowchart illustrating an example translation method according to various embodiments.

Referring to FIG. 3, the processor 120 may receive input of an original text and a user's translation intention in step S310. The user may input a sentence to be translated (e.g., an original text) and the user's translation intention through a keyboard, etc. provided on an external electronic device. In this case, the external electronic device may transmit the input original text and user's translation intention to the electronic device 100.

When the original text and the user's translation intention are input, the electronic device 100 may identify whether a word corresponding to the user's translation intention exists in training data in step S320.

Accordingly, in case a word corresponding to the user's translation intention does not exist in the training data in the step S320-N, the processor 120 may generate a translated text for the original text using a placeholder method in step S330. The processor 120 may provide the generated translated text in step S340.

In case a word corresponding to the user's translation intention exists in the training data in the step S320-Y, the processor 120 may generate a translated text for the original text using a target lemma annotation (TLA) method in step S350. The processor 120 may provide the generated translated text in step S360.

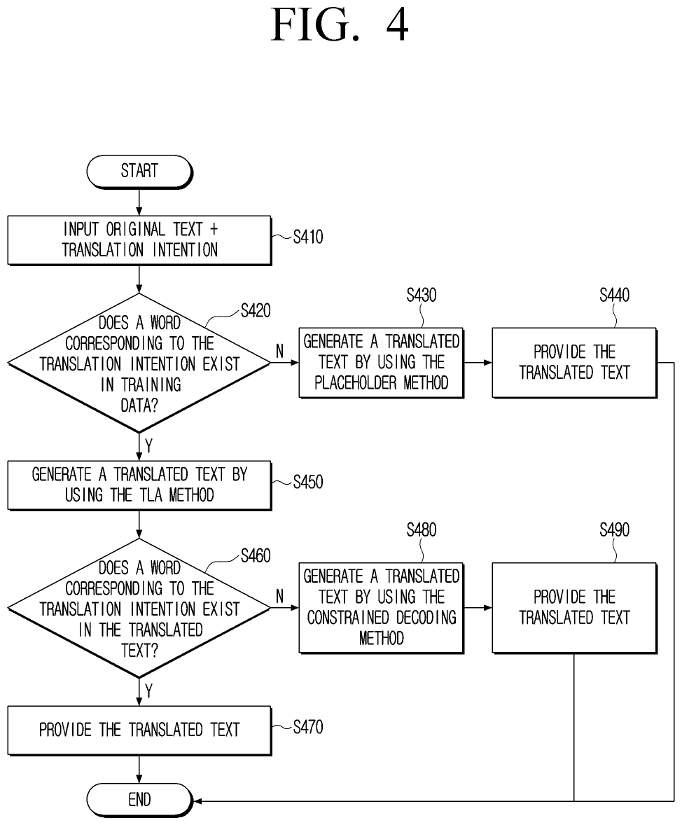

FIG. 4 is a flowchart illustrating an example translation method according to various embodiments.

As the steps S410 to S450 illustrated in FIG. 4 are the same as or substantially similar to steps S310 to S350 illustrated in FIG. 3, overlapping explanation may not be repeated here.

Referring to FIG. 4, after generating a translated text using the target lemma annotation method, the processor 120 may identify whether a word corresponding to the user's translation intention exists in the generated translated text in step S460.

Accordingly, in case a word corresponding to the user's translation intention exists in the generated translated text in step S460-Y, the processor 130 may provide the generated translated text in step S470.

In case a word corresponding to the user's translation intention does not exist in the generated translated text in step S460-N, the processor 130 may generate a translated text for the original text using a constrained decoding method in step S480. The processor 120 may provide the generated translated text in step S490.

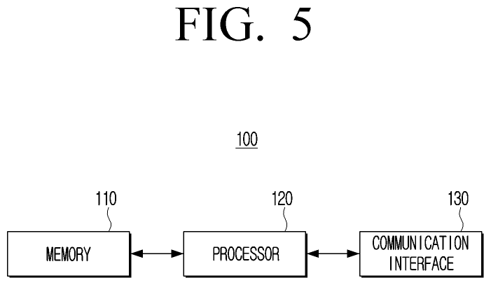

FIG. 5 is a block diagram illustrating an example configuration of an electronic device according to various embodiments.

Referring to FIG. 5, the electronic device 100 may include a communication interface (e.g., including communication circuitry) 130 in addition to the memory 110 and the processor 120. However, these components are merely examples, and it will be apparent that in carrying out the disclosure, new components can be added in addition to these components, or some components can be omitted. In describing FIG. 5, explanation that overlaps with FIG. 1 to FIG. 4 may not be repeated here.

The communication interface 130 includes circuitry. The communication interface 130 may communicate with an external electronic device. For example, the communication interface 130 may communicate with an external electronic device through an Internet network using a communication module.

Accordingly, the processor 120 may transmit and receive various types of data with the external electronic device through the communication interface 130. For example, the processor 120 may receive an original text and the user's translation intention from the external electronic device through the communication interface 130. The processor 120 may transmit a translated text for the original text to the external electronic device through the communication interface 130. The processor 120 may transmit a translated text in a text form or a voice form to the external electronic device through the communication interface 130. Accordingly, the external electronic device may display a screen including the translated text in a text form on the display, or output the translated text in a voice form through a microphone.

In the aforementioned example, it was explained that a plurality of translation models are stored in the memory 110, but this is merely an example. For example, in the memory 110, one translation model that was trained with respect to each of a plurality of translation methods (e.g., the target lemma annotation method, the placeholder method, the constrained decoding method) may be stored. In this case, the processor 120 may obtain a translated text that was translated from an original text through one translation method among the plurality of translation methods.

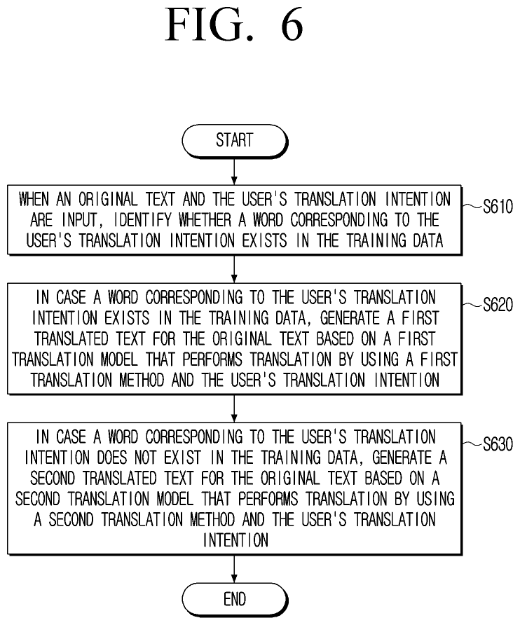

FIG. 6 is a flowchart illustrating an example method for generating a translated text of an electronic device according to various embodiments.

When an original text and the user's translation intention are input, it is identified whether a word corresponding to the user's translation intention exists in the training data in step S610.

In case a word corresponding to the user's translation intention exists in the training data, a first translated text for the original text is generated based on a first translation model that performs translation using a first translation method and the user's translation intention in step S620.

The first translation method may be the target lemma annotation method.

In case a word corresponding to the user's translation intention does not exist in the training data, a second translated text for the original text is generated based on a second translation model that performs translation using a second translation method and the user's translation intention in step S630.

The second translation method may be the placeholder method.

It is identified whether a word corresponding to the user's translation intention exists in the generated first translated text, and in case a word corresponding to the user's translation intention does not exist in the generated first translated text, a third translated text for the original text may be generated based on a third translation method and the user's translation intention.

The third translation method may be a constrained decoding method.

Functions related to artificial intelligence according to the disclosure may be operated through the processor 120 and the memory 110.

The processor 120 may include of one or plurality of processors 120. Here, the one or plurality of processors 120 may be generic-purpose processors such as a CPU, an AP, etc., graphic-dedicated processors such as a GPU, a VPU, etc., or artificial intelligence-dedicated processors such as an NPU.

The one or plurality of processors 120 perform control to process input data according to predefined (e.g., specified) operation rules or an artificial intelligence model stored in the memory 110. The predefined operation rules or the artificial intelligence model are characterized in that they are made through learning. The detailed description of the processor 120 above applies equally here.

Being made through learning may refer, for example, to predefined operation rules or an artificial intelligence model having desired characteristics being made by applying a learning algorithm to a plurality of training data. Such learning may be performed in a device itself wherein artificial intelligence is performed according to the disclosure, or performed through a separate server/system.

An artificial intelligence model may include a plurality of neural network layers. Each layer has a plurality of weight values, and performs an operation of the layer through an operation result of the previous layer and an operation of the plurality of weight values. As examples of a neural network, there are a convolutional neural network (CNN), a deep neural network (DNN), a recurrent neural network (RNN), a restricted Boltzmann machine (RBM), a deep belief network (DBN), a bidirectional recurrent deep neural network (BRDNN), deep Q-networks, or the like, and the neural network in the disclosure is not limited to the aforementioned examples.

A learning algorithm may refer, for example, to a method of training a specific subject device (e.g., a robot) using a plurality of training data and thereby making the specific subject device make a decision or make prediction by itself. As examples of learning algorithms, there are supervised learning, unsupervised learning, semi-supervised learning, reinforcement learning, or the like, but learning algorithms in the disclosure are not limited to the aforementioned examples excluding specified cases.

According to an embodiment of the disclosure, the method according to the various example embodiments of the disclosure may be provided while being included in a computer program product. A computer program product refers to a product, and it can be traded between a seller and a buyer. A computer program product can be distributed in the form of a storage medium that is readable by machines (e.g.: compact disc read only memory (CD-ROM)), or may be distributed directly between two user devices (e.g.: smartphones), and distributed on-line (e.g.: download or upload) through an application store (e.g.: Play Store™) In the case of on-line distribution, at least a portion of a computer program product (e.g.: a downloadable app) may be stored in a storage medium such as the server of the manufacturer, the server of the application store, and the memory of the relay server at least temporarily, or may be generated temporarily.

Also, each of the components (e.g.: a module or a program) according to the aforementioned various embodiments of the disclosure may include a singular object or a plurality of objects. In addition, among the aforementioned corresponding sub components, some sub components may be omitted, or other sub components may be further included in the various embodiments. Alternatively or additionally, some components (e.g.: a module or a program) may be integrated as an object, and perform functions that were performed by each of the components before integration identically or in a similar manner.

Operations performed by a module, a program, or other components according to the various embodiments may be executed sequentially, in parallel, repetitively, or heuristically. Or, at least some of the operations may be executed in a different order or omitted, or other operations may be added.

The term “a part” or “a module” used in the disclosure may include a unit implemented as hardware, software, or firmware, and may be interchangeably used with, for example, terms such as a logic, a logical block, a component, or a circuit. In addition, “a part” or “a module” may be a component included as an integrated body or a minimum unit or a part thereof performing one or more functions. For example, a module may include an application-specific integrated circuit (ASIC).

Meanwhile, a non-transitory computer readable medium storing a program that performs the control method according to the disclosure may be provided. A non-transitory computer readable medium refers to a medium that stores data, and is readable by machines. For example, the aforementioned various applications or programs may be provided while being stored in a non-transitory computer readable medium such as a CD, a DVD, a hard disc, a blue-ray disc, a USB, a memory card, ROM and the like.

Various embodiments of the disclosure may be implemented as software including instructions stored in machine-readable storage media, which can be read by machines (e.g.: computers). The machines refer to devices that call instructions stored in a storage medium, and can operate according to the called instructions, and the devices may include an electronic device according to the various embodiments disclosed herein (e.g.: the robot 100).

In case an instruction is executed by a processor, the processor may perform a function corresponding to the instruction by itself, and/or using other components under its control. An instruction may include a code that is generated or executed by a compiler or an interpreter.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. An electronic device comprising:
memory storing a first translation model configured to perform translation using a first translation method and a second translation model configured to perform translation using a second translation method; and
at least one processor, comprising processing circuitry, individually and/or collectively, configured to:
based on an original text and a translation intention being input, identify whether a word corresponding to the translation intention exists in training data, and
based on a word corresponding to the translation intention existing in the training data, generate a first translated text for the original text based on the first translation model and the translation intention, and
based on a word corresponding to the translation intention not existing in the training data, generate a second translated text for the original text based on the second translation model and the translation intention.

2. The electronic device of claim 1,
wherein the first translation method includes a target lemma annotation method.

3. The electronic device of claim 1,
wherein the second translation method includes a placeholder method.

4. The electronic device of claim 1,
wherein at least one processor, individually and/or collectively, is configured to:
identify whether a word corresponding to the translation intention exists in the generated first translated text, and based on a word corresponding to the translation intention not existing in the generated first translated text, generate a third translated text for the original text based on a third translation method and the translation intention.

5. The electronic device of claim 4,
wherein the third translation method includes a constrained decoding method.

6. A method for generating a translated text of an electronic device, the method comprising:
based on an original text and a translation intention being input, identifying whether a word corresponding to the translation intention exists in training data;
based on a word corresponding to the translation intention existing in the training data, generating a first translated text for the original text based on a first translation model configured to perform translation using a first translation method and the translation intention; and
based on a word corresponding to the translation intention not existing in the training data, generating a second translated text for the original text based on a second translation model configured to perform translation using a second translation method and the translation intention.

7. The method for generating a translated text of claim 6,
wherein the first translation method includes a target lemma annotation method.

8. The method for generating a translated text of claim 6,
wherein the second translation method includes a placeholder method.

9. The method for generating a translated text of claim 6, further comprising:
identifying whether a word corresponding to the translation intention exists in the generated first translated text; and
based on a word corresponding to the translation intention not existing in the generated first translated text, generating a third translated text for the original text based on a third translation method and the translation intention.

10. The method for generating a translated text of claim 9,
wherein the third translation method includes a constrained decoding method.

11. A non-transitory computer readable recording medium storing computer instructions that cause an electronic device to perform an operation when executed by at least one processor of the electronic device, wherein the operation comprises;
based on an original text and a translation intention being input, identifying whether a word corresponding to the translation intention exists in training data;
based on a word corresponding to the translation intention existing in the training data, generating a first translated text for the original text based on a first translation model configured to perform translation using a first translation method and the translation intention; and
based on a word corresponding to the translation intention not existing in the training data, generating a second translated text for the original text based on a second translation model configured to perform translation using a second translation method and the translation intention.

12. The medium of claim 11,
wherein the first translation method includes a target lemma annotation method.

13. The medium of claim 11,
wherein the second translation method includes a placeholder method.

14. The medium of claim 11, further comprising:
identifying whether a word corresponding to the translation intention exists in the generated first translated text; and
based on a word corresponding to the translation intention not existing in the generated first translated text, generating a third translated text for the original text based on a third translation method and the translation intention.

15. The medium of claim 14,
wherein the third translation method includes a constrained decoding method.
